(19) United States
(12) Patent Application Publication
(10) Pub. No.: US 2023/0285801 A1
(43) Pub. Date: Sep. 14, 2023

(54) Method, Apparatus and System for Determining Parameters of a Golf Swing

(71) Applicants: Robert Slade-Baker, Bracknell (GB); Jason Newell, Bracknell (GB); Souad Hadj-Said, Bracknell (GB)

(72) Inventors: Robert Slade-Baker, Bracknell (GB); Jason Newell, Bracknell (GB); Souad Hadj-Said, Bracknell (GB)

(21) Appl. No.: 17/693,526

(22) Filed: Mar. 14, 2022

(51) Int. Cl. A63B 24/00; A63B 71/06; A63B 69/36

(52) U.S. Cl. CPC A63B 24/0003; A63B 71/0622; A63B 69/3632; A63B 2225/02; A63B 2220/803; A63B 2220/62; A63B 2225/50; A63B 2220/40; A63B 2220/833

(57) ABSTRACT

The present disclosure provides computer-implemented methods and apparatus for determining one or more parameters of a golf swing in order to allow a user to optimise their stroke/swing/technique. The methods comprise the calibration of a device installed in a golf club with respect to a user device, allowing for the identification of the axes of a swing frame and thereby allowing motion detected by the installed device to be transposed into a useful orientation.

### FIELD OF INVENTION

The present invention relates generally to golf accessories and performance optimization, and more specifically relates to a method for calibrating a device for analyzing a golf swing so as to provide useful information to a player.

### BACKGROUND

Golf is a highly popular sport played both casually and competitively across the world. Many players wish to receive feedback on the form of their swing so that they can improve,

Some proposed training aids involve the installation of a device for sensing motion along the shaft to gauge swing parameters more accurately. Putters (golf clubs) are particularly suitable for such technology as they have a built-in indent for receiving such a device which is usually used for adjusting the weight of the putter by placing metal inserts of varying weight inside. These solutions have only been recently developed, as the necessary technology has only recently been miniaturized to a scale where such inserts can be placed on or in a club without interfering with the stroke entirely.

An issue with these solutions is the difficulty of determining useful parameters of the golf player's stroke from the perspective of the first device, which is referenced and aligned with the club rather than the player. The acceleration of the club head or shaft is not useful feedback for the player unless it is transposed into the frame of the player and used to calculate actual swing parameters. Currently there is no method or apparatus capable of making such transformations reliably.

It is within this context that the present invention is provided.

### SUMMARY

The present disclosure provides computer-implemented methods and apparatus for determining one or more parameters of a golf swing in order to allow a user to optimise their technique. The methods comprise the calibration of a device installed in a golf club with respect to a user device, allowing for the identification of the axes of a swing frame and thereby allowing motion detected by the installed device to be transposed into a useful orientation.

Thus, according to one aspect of the present disclosure there is provided a computer-implemented method for determining one or more parameters of a golf swing, the method comprising the steps of: receiving, by a first device configured to be installed in a golf club, an instruction from a second device to initiate a calibration protocol; determining, by the first device in coordination with the second device based on readings from one or more Inertial Measurement Units, IMUs, of the first device and from the second device, that the first device is in position for calibration and thereby determining a putter stroke frame.

The method further comprises collecting, by the first device, static readings from the one or more IMUs over a predetermined time period while the first device is in the position for calibration and thereby determining an X-axis and a Y-axis of the swing frame; monitoring, by the first device, one or more motion parameters of the first device sensed by the one or more IMUs, all subsequent IMU readings from the IMUs being continuously transposed into the swing frame; detecting, by the first device, a swing motion signature; recording, by the first device, one or more transposed motion parameters for the detected swing in the swing frame; storing, by the first device, the transposed motion parameters for the detected swing; and transmitting, by the first device, the transposed motion parameters for the detected swing to the second device.

In some embodiments, the position for calibration of the first device involves the user holding a golf club, in which the first device is installed, parallel to a flat surface, allowing alignment of the X and Y axes of the first device.

In some embodiments, a buffer period is implemented prior to collecting the static readings for the calibration, and gravity.

In some embodiments, the method further comprises the steps of: determining, by the first device, that a predetermined amount of time has elapsed with no motion detected.

In some embodiments, the method further comprises the steps of: entering, by the first device, a low power sleep mode when no motion is detected.

In such embodiments, the method further may comprise the steps of: detecting, by the first device, that the first device is in a wake-up position; and ending the low-power sleep mode.

In other embodiments, the method may further comprise the steps of: detecting, by the first device, a transmit motion signature; and transmitting, by the first device, transposed motion parameters for each detected swing stored in the first device's memory to the second device.

In some embodiments, the method the method further comprises the step of displaying, by the second device, instructions for how a user should position the first device during the calibration.

According to another aspect of the present disclosure there is provided an apparatus for determining one or more parameters of a golf swing, the apparatus comprising: a housing; a power source comprising charging circuitry disposed within the housing; a wireless communication module disposed within the housing; one or more inertial measurement units, IMUS, each comprising an accelerometer and gyroscope, disposed within the housing; a base cover; and a controller disposed within the housing and configured to carry out the operations of the first device in the method of any one of the above-described embodiments.

In some embodiments, an O-ring is disposed about the cylinder wall of the housing to form a seal with an opening of a golf club.

In some embodiments, the power source is configured for charging, be it for either wireless charging or direct charging through the use of pogo pins, or any other means.

In some embodiments, the wireless communication module comprises a Wireless Low Energy transceiver configured to transmit data on multiple frequencies.

In some embodiments, the base cover is supplied in various weights and/or sizes for matching a weight of the golf club in which it is to be installed.

In some embodiments, the housing is provided with one or more indents for interlocking or extraction with an installation tool.

According to yet another aspect of the present disclosure, there is provided a system for assisting a user in optimising their golf swing, the system comprising: one or more servers; one or more user devices in communication with the one or more servers, each user device being configured to carry out the operations of the second device in the above-described methods; and apparatus according to the above-described embodiments, wherein the one or more user devices are configured to transmit the transposed motion parameters for the detected swing to the one or more servers for storage and further analysis.

### BRIEF DESCRIPTION OF THE DRAWINGS

Various embodiments of the invention are disclosed in the following detailed description and accompanying drawings.

FIG. 1 illustrates a flow diagram of a set of steps of a method according to the present disclosure.

FIG. 2 illustrates a transition implemented in the disclosed method from a set of axes forming a device frame to a set of axes forming a swing frame.

FIG. 3A-FIG. 3I illustrate an example set of steps followed by a user in calibrating a device according to the disclosed method as instructed on an interface of a user device.

FIG. 4A and FIG. 4B illustrate an isometric view and cutaway view of an example configuration of an apparatus according to the present disclosure for use in accordance with the disclosed method.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As mentioned above the present disclosure provides a unique method for calibrating a device insert, to be installed within a golf club such that useful parameters about a golf player's swing can be determined and provided to the player as feedback. An apparatus in accordance with the disclosed method is also provided, as well as a system for managing the data.

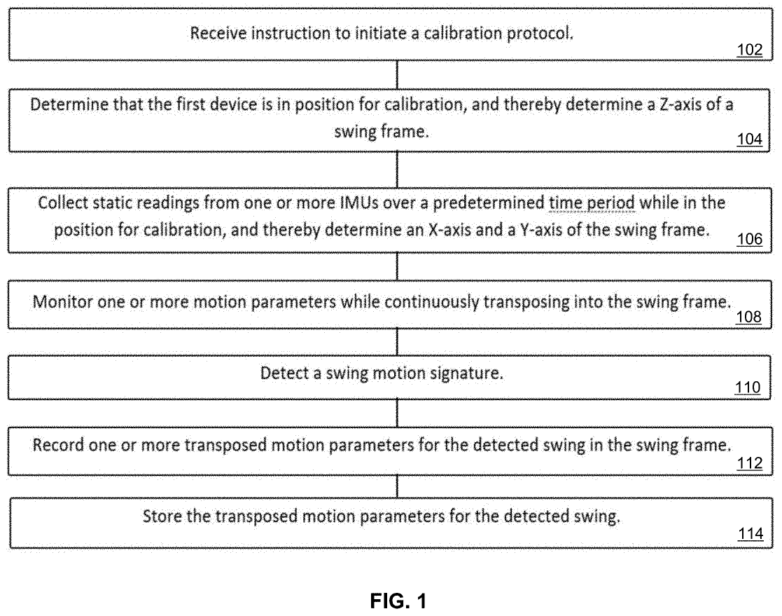

Referring to FIG. 1, a flow diagram of a set of steps of the disclosed method is shown.

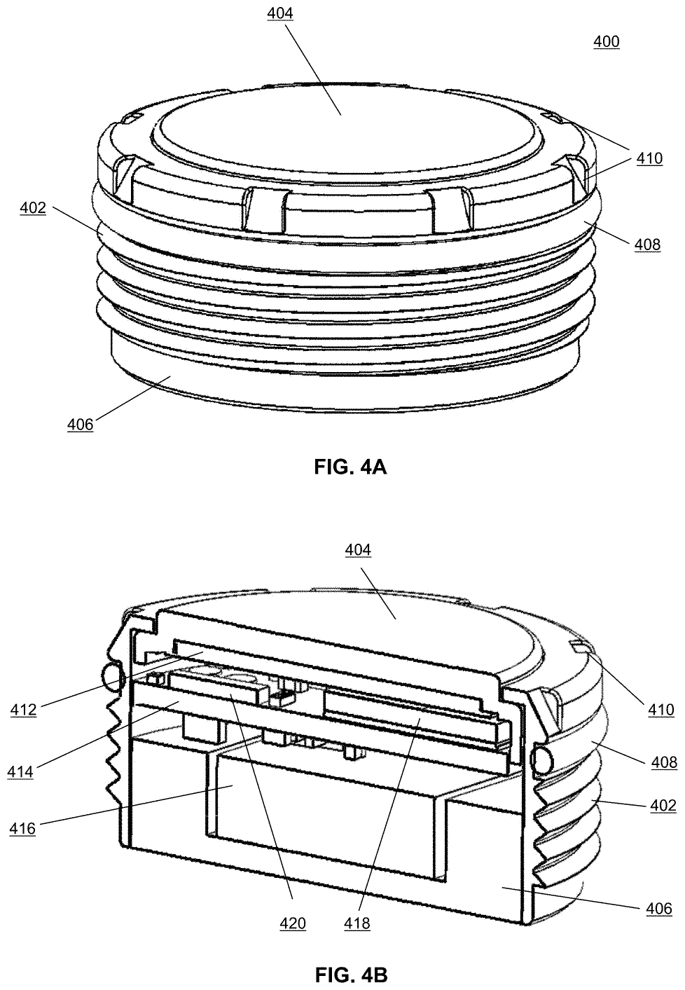

In a first step 102, the method involves receiving, by a first device configured to be installed in a golf club, an instruction from a second device to initiate a calibration protocol. The first device may for example be an apparatus according to the present disclosure as described with respect to FIG. 4A and FIG. 4B below.

Such devices can be inserted into the head of a putter in place of a weighting element and comprise one or more Inertial Measurement Units, IMUs, as well as wireless transceiver for communicating with the second device.

The second device may for example be a user's smartphone or tablet, configured with an application for communicating with the first device, as will be explained in more detail below.

In a second step 104, the method involves determining, by the first device in coordination with the second device based on readings from one or more IMUs of the first device and of the second device, that the first device is in position for calibration and thereby determining a Z-axis of a “swing frame”.

For example, a user may be instructed to place the first device, which may or may not already be installed in a golf club, in a static position above a flat surface.

In a third step 106, the method involves collecting, by the first device, static readings from the one or more IMUs over a predetermined time period while the first device is in the position for calibration, and thereby determining an X-axis and a Y-axis of the swing frame.

With the vertical Z axis known with certainty, small changes in orientation with respect to the vertical can be used to fully determine the orientation of the device. This solves a big issue with such apparatus, since it is often screwed into the rear indent of a putter club, with no predetermined fixed orientation and has no way of determining these X and Y axes.

In a fourth step 108, the method involves monitoring, by the first device, one or more motion parameters of the first device sensed by the one or more IMUs, all subsequent IMU readings from the IMUs being continuously transposed into the swing frame.

After this calibration, the orientation of the first device will be changed as the golf club is moved around, but the first device will be able to continuously recalculate its own axes relative to the “swing frame” X, Y, and Z axes, and thus the raw data will be able to be changed into useful parameters and feedback for the golfer that actually give insight into their swing and how they can optimise it.

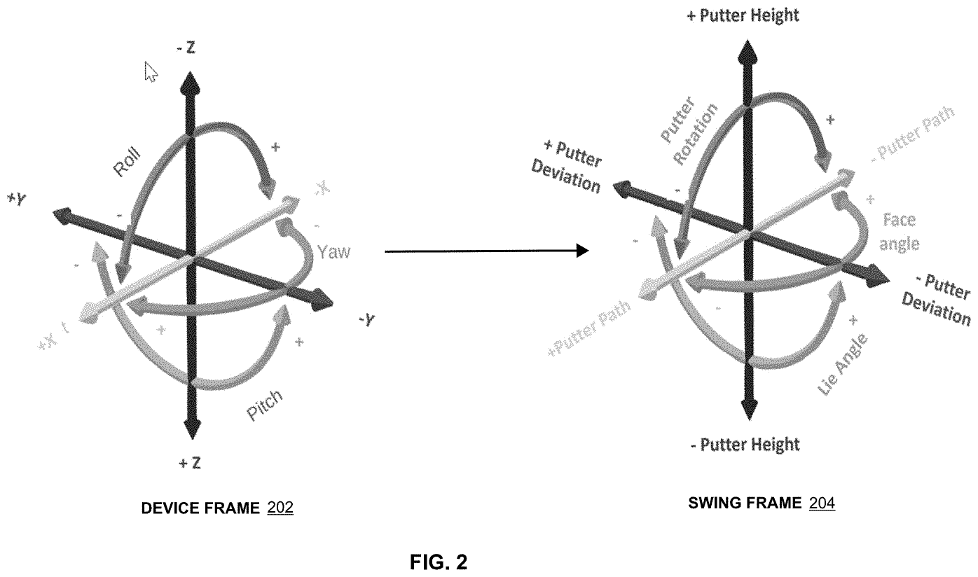

The transition from the “device frame” 202, where the axes are the axes of the first device itself and remain constant with respect to the first device into the swing frame 204, is shown in more detail with reference to FIG. 2

In a fifth step 110, the method involves detecting, by the first device, a swing motion signature. The swing signature may, for example, be a sharp motion which, when transposed into the swing frame, meets a set of threshold conditions and allows an algorithm running on the controller of the first device to determine with certainty that a user has made a swing attempt. Various checks may be implemented prior to confirmation of the swing signature to make sure that practice swings and false detections are avoided.

In a sixth step 112, the method involves recording, by the first device, one or more transposed motion parameters for the detected swing in the swing frame. When the swing signature is confirmed, the device will determine and associate a number of parameters with that swing. This may involve determining a swing start time and end time and calculating a variety of different parameters based on the accelerations experienced by the one or more IMUS of the first device in that time interval.

A list of possible examples of the parameters calculated, alongside their units of measurement and resolution in the swing frame, is included below in table 1.1:

TABLE 1.1

| Measurements | Unit | Resolution |
|---|---|---|
| Path Direction | Angle, ° | 0.1 |
| Rhythm | Number | 0.1 |
| Tempo | Number | 1 |
| Backstroke Time | Time, s | 0.01 |
| Forward Stroke Time | Time, s | 0.01 |
| Total Stroke Time | Time, s | 0.01 |
| Face Rotation change - Back | Angle, ° | 0.1 |
| Club Head Speed (Impact) | Velocity, m/s | 0.01 |
| Backstroke Length | Displacement, mm | 1 |
| Back stroke Rotation | Angle, ° | 0.1 |
| Forward Stroke Rotation | Angle, ° | 0.1 |
| Face Change | Angle, ° | 0.1 |
| Loft Angle (Impact) | Angle, ° | 0.1 |
| Lie Angle (Change) | Angle, ° | 0.1 |
| Face Rotation change - Forward | Angle, ° | 0.1 |
| Attack Angle | Angle, ° | 0.1 |
| Post Impact Stroke Length | Displacement, mm | 1 |
| Full Stroke Length | Displacement, mm | 1 |
| Club Head Acceleration | Acceleartion, m/s2 | 0.01 |
| Shaft Lean (Change) | Angle, ° | 0.1 |
| Impact Point (H) | Displacement, mm | 1 |
| Impact Point Change (H) | Displacement, mm | 1 |
| Impact Point (V) | Displacement, mm | 1 |
| Gear Effect/Twist | Number | 0.1 |
| Aim/Alignment | Angle, ° | 0.1 |
| Face Angle 10 Cm > Address | Angle, ° | 0.1 |
| Face Angle 10 Cm < Impact | Angle, ° | 0.1 |
| Face Angle 10 Cm > Impact | Angle, ° | 0.1 |
| Face Angle Change 10 Cm > Address | Angle, ° | 0.1 |
| Face Angle Change 10 Cm < Impact | Angle, ° | 0.1 |
| Face Angle Change 10 Cm > Impact | Angle, ° | 0.1 |
| Path Relative To Arc | Angle, ° | 0.1 |
| Shaft Lean (Address) | Angle, ° | 0.1 |
| Shaft Lean (Impact) | Angle, ° | 0.1 |
| Lie Angle (Address) | Angle, ° | 0.1 |
| Lie Angle (Impact) | Angle, ° | 0.1 |
| Loft Angle (Address) | Angle, ° | 0.1 |
| Loft Angle (Change) | Angle, ° | 0.1 |
| Calibration Angle | Angle, ° | 0.1 |
| Lie Calibration Angle | Angle, ° | 0.1 |

In a seventh step 114, the method involves storing, by the first device, the transposed motion parameters for the detected swing. The method may then further comprise a step of transmitting, by the first device, the transposed motion parameters for the detected swing to the second device. In some examples the device may immediately send the parameters of the swing to the second device after calculating them, but in other examples it may be more convenient or energy efficient to store them in a memory of the device until a batch of parameters associated with different swings are sent.

The controller of the first device may be programmed in various ways to save power by entering and leaving a “sleep mode” when not in use. For example, the device may determine that a predetermined amount of time has elapsed with no swing signature detected and enter a low power sleep mode in response to the determination. When in sleep mode, the device may be programmed to monitor for a specific orientation or motion, and wake up in response to a detection of that orientation or motion. In some examples, the device may wake up when it detects it is being held in a putt position, ending the low power sleep mode in response.

The controller of the first device may also be configured to detect other signature motions and perform certain operations in response to those. For example, the device may be programmed to monitor for a “transmit” motion signature. When the transmit motion signature is detected, the device may be configured to upload all of the stored swing data to a connected user device. For example, the device may detect that the golf club is being held in an upright position and/or the golf head has been tapped twice in a row in a vertical position, and transmit the stored swing data, via a wireless connection or otherwise, in response.

The calibration and determination of swing metrics in the above method is generally implemented by a user holding the first device, or a golf club with the first device installed therein, in close proximity to a user device such as their smartphone. The smartphone may have a set of dedicated software installed thereon for performing the necessary operations, and may also be configured to display instruction(s) to the user for correctly calibrating the first device.

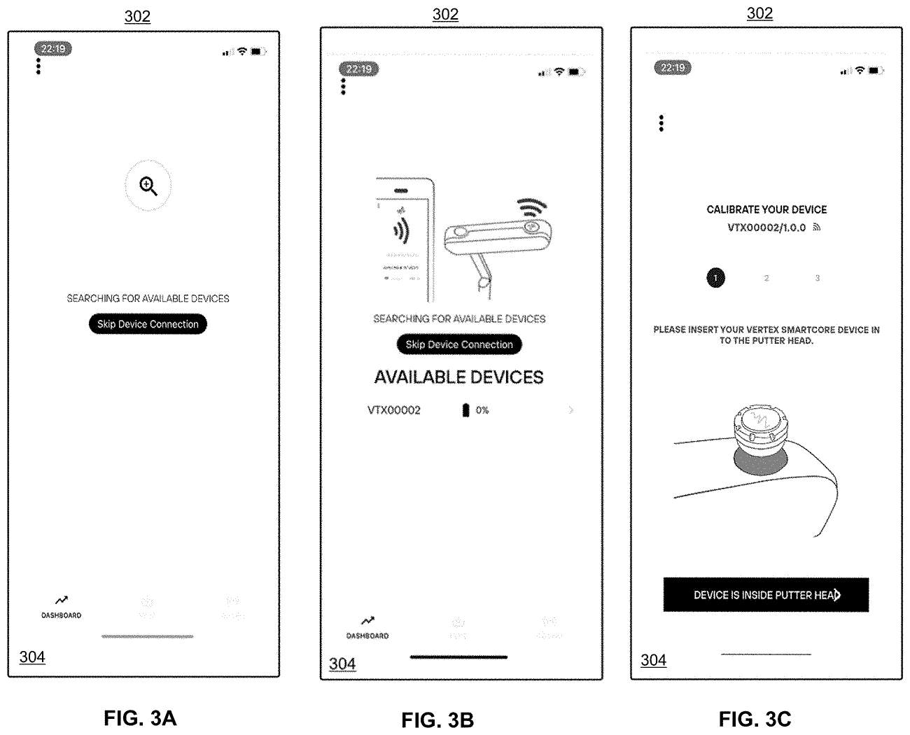

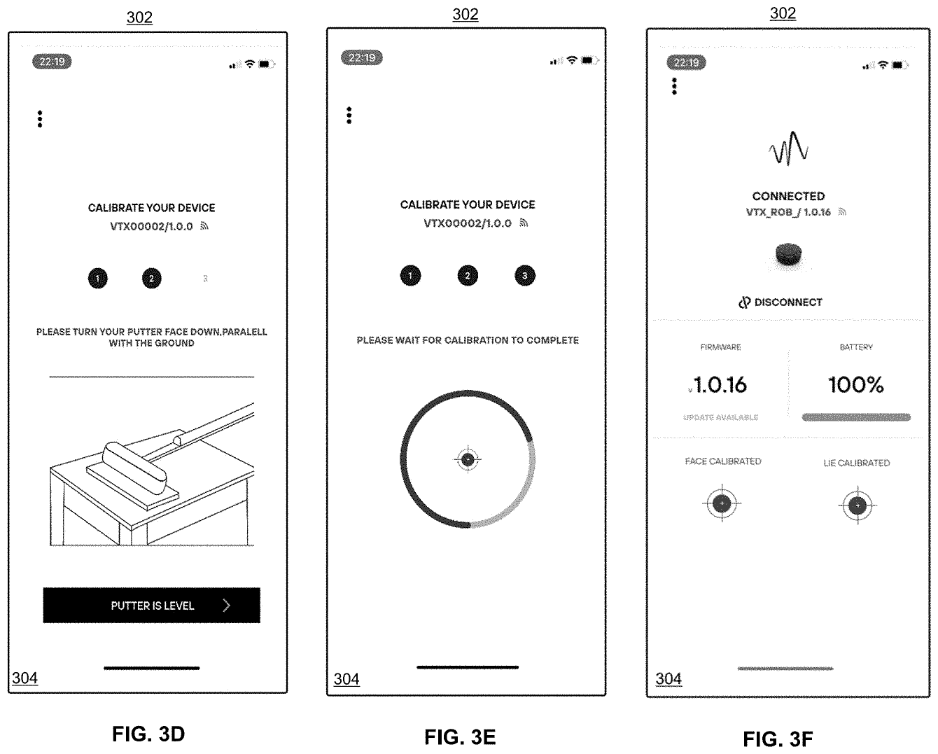

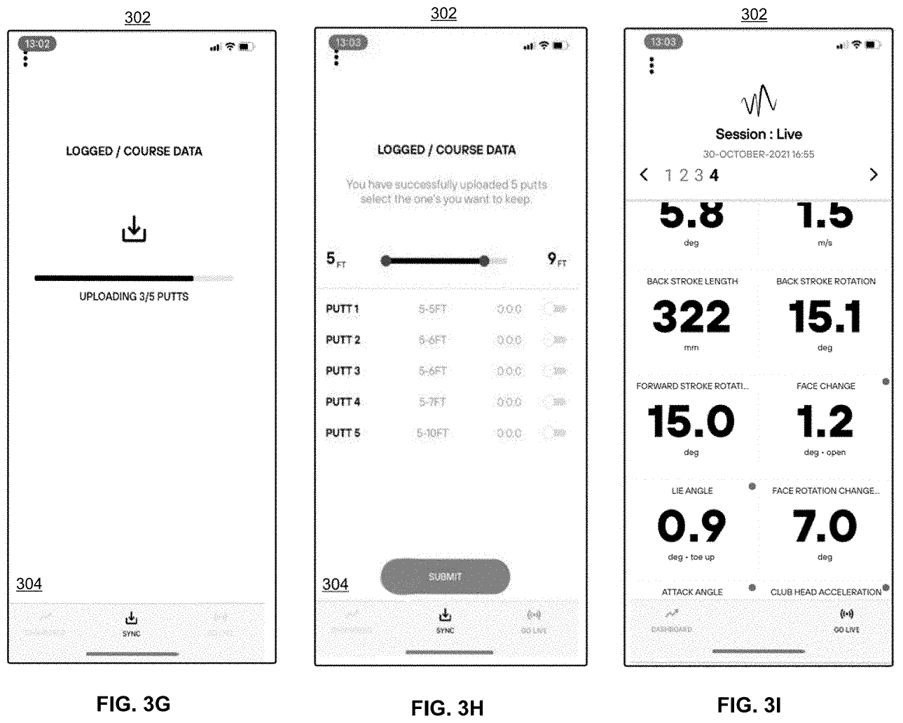

Thus, with reference to FIGS. 3A-3I, a set of user device display 302 screenshots are shown as a user proceeds with connecting their phone to the first device, calibrating it, and receiving swing data transposed into the swing frame. The operations are carried out from a dedicated application having a dashboard interface 304 where the user may enact various operations between the user device and the first device.

In particular, FIG. 3A shows the user device searching for nearby devices to interact with, this may for example involve monitoring for advertised, wireless beacon signals on one or more frequency channels.

FIG. 3B shows that a nearby device has been located and determined as available via a handshake operation.

FIG. 3C shows the user device connected to the nearby first device, and the interface instructing a user to insert or attach the first device to their golf club if they have not done so already, so that the calibration can determine a swing frame from the perspective the device will have while coupled to the club during a swing. Once inserted, a button is provided for a user to proceed with the calibration.

FIG. 3D shows the user interface instructing the user to position their device above their user device on a flat surface, i.e., in calibration position for the determination of the Z axis of the swing frame. Once the position of the golf club is correct the user may press a button on the interface to proceed with the calibration.

FIG. 3E shows the actual calibration taking place, where readings are taken in a static position for a set amount of time to determine the X and Y axes of the swing frame with the first device inserted in to the golf club.

FIG. 3F shows the user interface of the user device with the calibration completed and the first device ready to capture data in the swing frame and ready to record and store swing parameters for each time a swing signature is detected. A number of detected swing signatures (and thus a number of stored metrics ready to be transmitted upon instruction by a user) is tracked on the bottom left of the interface.

FIG. 3G shows that a user has instructed the first device to transmit the stored swing data to the user device and it is in the process of being uploaded.

FIG. 3H shows the interface once the set of swing data has been uploaded, with various swings available for browsing, each having their own set of detected swing parameters.

FIG. 3I shows the interface displaying a set of swing parameters associated with one of the swings from the uploaded set. As can be seen, the data is not raw accelerometer and gyroscope data from the reference frame of the device itself, but has been transposed into useful feedback for the golfer such as back stroke length, back stroke rotation, attack angle, etc. The player can view multiple sets of such data and determine patterns in their swings that may not be optimal and correct within them.

Referring to FIG. 4A and FIG. 4B, one example configuration of an apparatus 400 for implementing the method of the present disclosure is shown in both an isometric view and cutaway view.

The illustrated example is designed to be inserted in the rear of a putter golf club head. It comprises a housing 402 with a screw-in design, in accordance with other putter inserts, and a protective exterior cap 404 to prevent the internal circuitry from being damaged during use.

The bottom cover 406 of the apparatus may be weighted so as to simulate the weight and feel of a real putter insert. In some examples the bottom cover 406 is supplied with differently weighted covers along with the apparatus in a kit, to vary the putter weight according to a player's preferences.

The outer walls of the housing 402 may be provided with an O-ring seal 408 for sealing the apparatus inside the putter's opening. Furthermore, the edge of the housing surrounding the protective cap 404 may be provided with one or more grips or indents for interfacing with an installation and/or extraction tool designed to help remove the insert from the putter.

A QI receiver coil 412 may be provided underneath the cover 404 to facilitate wireless charging of the device without removal from the putter each time. The control board 414 housing the circuitry may be disposed underneath the charging coil 412. A rechargeable battery or other power source 416 is disposed within the bottom cover 406 and is coupled to both the control board 414 and the receiver coil 412.

A microprocessor 418 or other type of miniature controller is mounted to the control board and configured to carry the operations of the first device as described above, the microprocessor 418 either incorporates or is coupled to a wireless transceiver. One or more IMUs 420 are also mounted thereon. Each IMU 420 comprises at least an accelerometer, gyroscope and/or magnetometer, and in a preferred embodiment each device is provided with two or more IMUs coupled to the controller.

While the illustrated example is specifically designed for insertion into a putter, it may also be mounted to the club shaft and other club type(s). In some examples a shaft mount/clip may be provided alongside the apparatus for facilitating this.

As mentioned above, the disclosed method may be implemented via a system incorporating a user device, and apparatus such as that described with respect to FIGS. 4A and 4B, and a wireless network including one or more servers and databases. Said servers may be configured to receive and manage swing data from multiple devices and/or multiple players and perform further analysis thereon.

The user device mentioned above may be a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

It should be understood that the operations described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re-implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method, apparatus and system for determining useful parameters of a golf swing have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for determining one or more parameters of a golf swing, the method comprising the steps of:
receiving, by a first device installed in a golf club, an instruction from a second device to initiate a calibration protocol;
determining, by the first device in coordination with the second device based on readings from one or more Inertial Measurement Units, IMUs, of the first device and of the second device, that the first device is in position for calibration and thereby determining a Z-axis of a swing frame;
collecting, by the first device, static readings from the one or more IMUs over a predetermined time period while the first device is in the position for calibration and thereby determining an X-axis and a Y-axis of the swing frame;
monitoring, by the first device, one or more motion parameters of the first device sensed by the one or more IMUs, all subsequent IMU readings from the IMUs being continuously transposed into the swing frame;
detecting, by the first device, a swing motion signature;
recording, by the first device, one or more transposed motion parameters for the detected swing in the swing frame;
storing, by the first device, the transposed motion parameters for the detected swing; and
transmitting, by the first device, the transposed motion parameters for the detected swing to the second device.

2. A computer-implemented method according to claim 1, wherein the position for calibration of the first device involves the user holding the golf club in which the first device is installed parallel to a flat surface, allowing alignment of the vertical axes of the first device and identification of the Z-axis of the swing frame.

3. A computer-implemented method according to claim 1, wherein the method further comprises the steps of:
determining, by the first device, that a predetermined amount of time has elapsed with no swing signature detected; and
entering, by the first device, a low power sleep mode.

4. A computer-implemented method according to claim 3, wherein the method further comprises the steps of:
detecting, by the first device, that the first device is in a wake-up position; and
ending the low-power sleep mode.

5. A computer-implemented method according to claim 3, wherein the method further comprises the steps of:
detecting, by the first device, a transmit motion signature; and
transmitting, by the first device, transposed motion parameters for each detected swing stored in the first device's memory to the second device.

6. A computer-implemented method according to claim 1, wherein a buffer period is implemented prior to collecting the static readings for the calibration.

7. A computer-implemented method according to claim 1, wherein monitoring the one or more motion parameters involves running, by the first device, a putt detect algorithm at regular intervals to check whether the one or more parameters fall within one or more predetermined thresholds.

8. A computer-implemented method according to claim 1, wherein the method further comprises the step of receiving and displaying, by the second device, the one or more motion parameters from the detected swing in the swing frame in an interface of the second device.

9. A computer-implemented method according to claim 8, wherein the method further comprises uploading, by the second device, the one or more parameters for the detected swing to a server for storage and analysis.

10. A computer-implemented method according to claim 1, wherein the method the method further comprises the step of displaying, by the second device, instructions for how a user should position the first device during the calibration.

11. Apparatus for determining one or more parameters of a golf swing, the apparatus comprising:
a cylindrical housing;
a power source comprising charging circuitry disposed within the housing;
a wireless communication module disposed within the housing;
one or more inertial measurement units, IMUs, each comprising an accelerometer and gyroscope, disposed within the housing;
a base cover; and
controller disposed within the housing and configured to carry out the operations of the first device in the method of claim 1.

12. (canceled)
